(19) United States
(12) Patent Application Publication
(10) Pub. No.: US 2024/0017366 A1
(43) Pub. Date: Jan. 18, 2024

(54) MANUFACTURING DEVICE FOR A DENTAL RESTORATION

(71) Applicant: Ivoclar Vivadent AG, Schaan (LI)

(72) Inventors: Christian Wellinger, Nüziders (AT); Jonas Reinhardt, Igis (CH); Alen Frey, Feldkirch (AT); Hannes Gurschler, Schlanders (IT)

(21) Appl. No.: 18/351,781

(22) Filed: Jul. 13, 2023

(30) Foreign Application Priority Data
Jul. 14, 2022 (EP) 22184944.1

(51) Int. Cl. B23Q 17/09; A61C 13/00

(52) U.S. Cl. CPC B23Q 17/0961; A61C 13/0022

(57) ABSTRACT

A manufacturing device (100) for a dental restoration (200), including a tool (101) for machining a blank (201); a detector (103) for detecting a spindle current of a turning spindle (117); and a calculator (105) for calculating wear of the tool (101) based on the spindle current.

### CROSS-REFERENCE TO RELATED APPLICATIONS

This application claims priority to European Patent Application No. 22184944.1 filed on Jul. 14, 2022, the disclosure of which is incorporated herein by reference in its entirety.

### TECHNICAL FIELD

The present invention relates to a dental restoration manufacturing device and a dental restoration manufacturing method.

### BACKGROUND

Currently, in the production of dental restorations by milling or grinding processes, the running meters covered by a grinder along milling paths are added up to determine wear of the grinder. Once an empirical value is reached, a message is issued to an operator that the grinder should be replaced. However, the actual wear of the grinder cannot be determined this way. Even though a user uses an old or damaged grinder, a machine will not recognize this. Therefore, these procedures are prone to error.

US 20090129882 and 20230113517 are directed to methods and systems for monitoring tools and/or detecting the condition of tools in dental milling machines and are hereby incorporated by reference in their entirety.

### SUMMARY

It is therefore the technical task of the present invention to more accurately predict wear of a tool during the machining or manufacturing of a dental restoration.

This technical task is solved by the subject matters according to the independent claims. Technically advantageous embodiments are the subject matter of the dependent claims, the description and the drawings.

According to a first aspect, the technical task is solved by a manufacturing device for a dental restoration, comprising a tool for machining a blank; a detecting device or detector for detecting a spindle current of a turning spindle; and a calculating device or calculator for calculating wear of the tool based on the spindle current. The tool may be a milling tool, a grinding tool, or a polishing tool. By means of the manufacturing device, for example, the technical advantage is achieved that a worn or defective tool can be detected.

In a technically advantageous embodiment of the manufacturing device, the calculator is configured to calculate the wear from several measured values of the spindle current. This achieves, for example, the technical advantage that the accuracy of the calculation can be improved.

In a further technically advantageous embodiment of the manufacturing device, the calculator is configured to sum up or average the spindle current from several measured values. Therefore, for example, the technical advantage is achieved that the calculation of the spindle current can be further improved.

In a further technically advantageous embodiment of the manufacturing device, the calculator is configured to calculate the wear from a sliding time window for the spindle current. Therefore, for example, the technical advantage is achieved that accurate and current values for the spindle current are obtained during a machining operation.

In a further technically advantageous embodiment of the manufacturing device, the calculator is configured to calculate an interval for the average 50% of the values of the spindle current. Therefore, for example, the technical advantage is achieved that the value for the spindle current can be determined precisely and outlying values are not taken into account.

In a further technically advantageous embodiment of the manufacturing device, the calculator is configured to calculate the wear from the width of the interval. Thus, for example, the technical advantage is achieved that a proportional relationship results between the width of the interval and the wear.

In a further technically advantageous embodiment of the manufacturing device, the calculator is configured to calculate the wear of the tool in proportion to the width of the interval. Thus, for example, the technical advantage is achieved that the wear can be determined in a simple and quick manner.

In another technically advantageous embodiment of the manufacturing device, the manufacturing device is configured to compensate for the wear of the tool during machining. This provides the technical advantage, for example, that the dental restoration can be produced with a high degree of accuracy even when the tool begins to wear.

In another technically advantageous embodiment of the manufacturing device, the manufacturing device comprises a replacement device or replacer for replacing a worn tool with an unworn tool. Thus, for example, the technical advantage is achieved that a worn tool can be replaced in a simple manner.

In a further technically advantageous embodiment of the manufacturing device, the replacer is configured to automatically change the tool when a given wear level is exceeded. Thus, for example, the technical advantage is achieved that machining can be continued immediately with a new tool when the tool is worn out. In addition, no material is spoiled or wasted. The data could also be stored and used for quality purposes.

According to a second aspect, the technical task is solved by a manufacturing method for a dental restoration, comprising the steps of detecting a spindle current of a turning spindle; and calculating wear of the tool based on the spindle current. By means of the manufacturing method the same technical advantages are achieved as with the manufacturing device according to the first aspect.

In a technically advantageous embodiment of the manufacturing method, the wear is calculated from several measured values of the spindle current. This also achieves, for example, the technical advantage that the accuracy of the calculation can be improved.

In a further technically advantageous embodiment of the manufacturing method, the wear is calculated from a sliding time window for the spindle current. This also achieves, for example, the technical advantage that the calculation of the spindle current can be further improved.

In a further technically advantageous embodiment of the manufacturing method, an interval is calculated for the average 50% of the values of the spindle current. This also achieves the technical advantage, for example, that the value for the spindle current can be determined precisely and outlying values are not taken into account.

In a further technically advantageous embodiment of the manufacturing method, the wear is calculated from the width of the interval. This also achieves the technical advantage, for example, that a proportional relationship between the width of the interval and the wear is produced.

### BRIEF DESCRIPTION OF THE DRAWINGS

Examples of embodiments of the invention are represented in the drawings and are described in more detail below.

The drawings show:

FIG. 1 a schematic representation of a dental restoration manufacturing device;

FIG. 2 a deviation of nominal and actual dimension with different test specimens;

FIG. 3 a view of a milling tool;

FIG. 4 a schematic distribution of measured values for the spindle current;

FIG. 5 several interquartile ranges as a function of nominal/actual differences of consecutively manufactured test specimens; and

FIG. 6 block diagram of a manufacturing method for a dental restoration.

### DETAILED DESCRIPTION

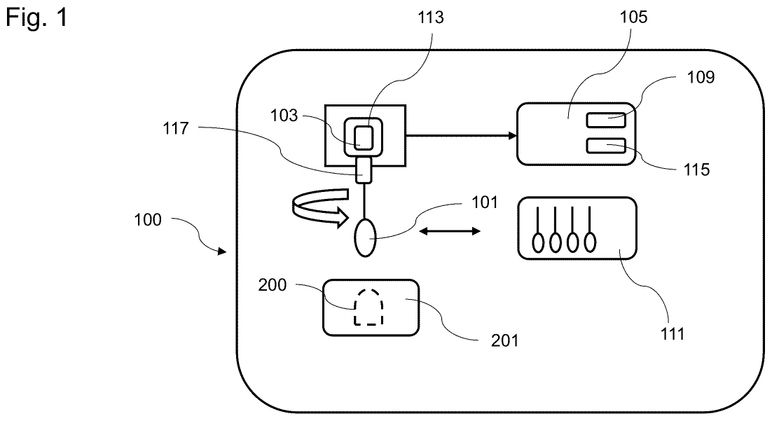

FIG. 1 shows a schematic representation of a dental restoration 200 manufacturing device 100. The dental restoration 200 is, for example, a crown, a bridge, a veneer, an abutment, an inlay, an onlay, a splint, or a partial or a full denture.

The manufacturing device 100 comprises a tool 101 for machining a blank 201, such as a milling tool or a grinding tool. By means of the tool 101, the blank 201 is formed into the desired shape of the dental restoration 200 by means of a chip-removing process. The blank is, for example, a disc of zirconium oxide. The tool 101 is driven by an electric motor 113 and is set into rotation by means of a turning spindle 117. On this occasion, an electric spindle current flows through the electric motor 113 of the turning spindle 117.

The manufacturing device 100 additionally comprises a detector 103 for detecting the spindle current of the turning spindle 117 for the tool 101 when processing the blank 201. The detector 103 may comprise a current sensor that measures the electric current flowing through the electric motor 113. The detection of the spindle current may be carried out using existing sensor or machine data, so that no additional sensors are used. The higher the values, such as the standard deviation or interquartile range IQR, of the electrical spindle current during machining, the larger is the wear of the tool 101. The higher the IQR, the larger is the wear of the tool 101. By means of the current sensor, for example, digital values for the spindle current can be continuously obtained.

In order to calculate the exact wear of the tool 101, the manufacturing device 100 comprises a calculator 105. It may be formed by a microprocessor 115 having a memory 109. The microprocessor 115 receives the digital values for the spindle current and processes them by using an algorithm in order to obtain a digital value for the wear. The digital value for wear may then be stored in the memory 109.

The calculator is thereby able to continuously and in real time calculate the wear of the tool 101 based on the spindle current. The spindle current is used to analyze the condition of the tool 101. For example, the condition of the tool 101 can be determined using the spindle current when machining dental glass ceramics.

However, the calculator 105 may also be configured to assign a given wear of the tool 101 to a detected spindle current. In this case, a digital look-up table (Look Up Table) may be used to assign a corresponding wear of the tool 101 to each value for the spindle current.

For example, the actual condition of the tool 101 during each machining operation can be determined hereby. Thus, old, worn or defective tools can be detected in due time. A deviation of the dimension in the production can be corrected on the basis of the determined wear of the tool 101.

The manufacturing device 100 may also control a rotational speed of the tool 101 based on the detected spindle current. After reaching a predetermined value of wear, the rotational speed, infeed, and/or feed rate of the tool 101 may be adjusted or reduced. As a result, the load on the tool 101 at the end of its service life can be reduced. By means of the manufacturing device 100 the quality of the dental restoration is increased and less waste is produced.

The determined wear of the tool 101 can then be compensated when machining the dental restoration 200. If the wear of the tool 101 is 5 μm, for example, this value can be added to an actual position of the tool 101 during milling in order to obtain a desired nominal position. As a result, the dental restoration 200 can be produced in the desired dimension even if the tool 101 is partially worn.

Further, the manufacturing device 100 may include a tool replacer 111 for replacing a worn tool 101 with an unworn tool 101. For this purpose, for example, a plurality of identical tools 101 are provided in a magazine. Once the tool 101 used to perform a machining operation of the dental restoration 200 has a predetermined wear, it is automatically replaced by a new tool 101 from the magazine, for example by means of an electromechanical change mechanism or gripper. This allows numerous dental restorations 200 to be mass produced without requiring user intervention.

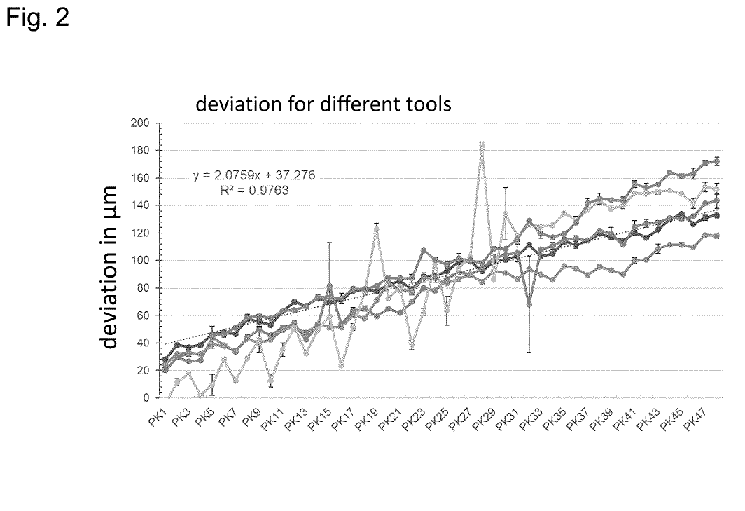

FIG. 2 shows a deviation of nominal and actual dimension for different tools 101 with an increasing number of test specimens PK. The older the tool, the further the actual dimension (measured at the part) is distant from the nominal dimension. The deviation increases by 2 μm per test specimen.

The increasing deviation can lead to waste during production. In the case of a crown, for example, this means that the hole becomes smaller by 2 μm per crown produced. After a number of approximately 40 test specimens (deviation 80 μm), the crown no longer fits on the die or stump. In this case, for example, a manufactured crown or bridge will not fit for a patient because the dimensions are not correct.

If a deviation is determined based on the spindle current, an analysis over 10 seconds at a high sampling rate is sufficient to determine wear. The condition of the tool 101 can be predicted accurately to ±7 test specimens, which corresponds to a deviation of approx. ±14 μm. For each milled test specimen, there is a wear on the tool of approx. 2 μm.

The sampling rate describes the frequency at which an analog signal is read within a certain time and is converted into a discrete-time signal. The sampling rate for the spindle current, for example, is 10 kHz. Thus, 10,000 measured values for the spindle current can be obtained in one second.

The spindle current can be detected in a sliding time window so that the measured values of the spindle current for a predetermined period in the past are always used. The time window therefore includes a predetermined set of more recent measured values. This has the result that older measured values that drop outside the sliding time window are no longer taken into account when calculating the spindle current.

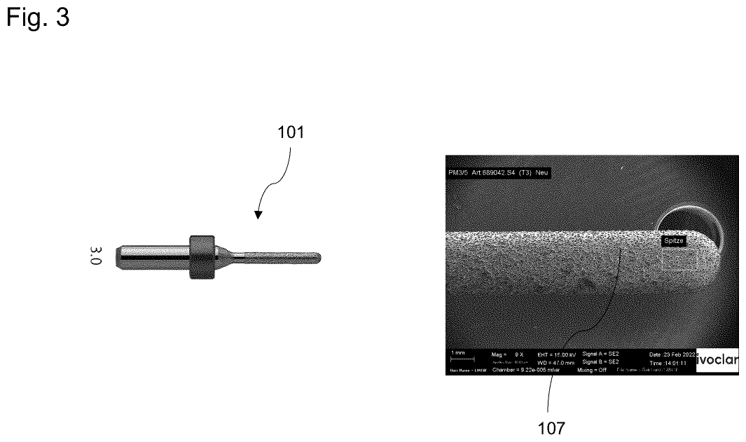

FIG. 3 shows a view of a tool 101. The tool may be, for example, a grinder or a cutter for the dental restoration 200. The tool 101 comprises, for example, a diamond-studded milling surface 107. The milling surface 107 is in contact with the blank 201 in order to mill the dental restoration out of it.

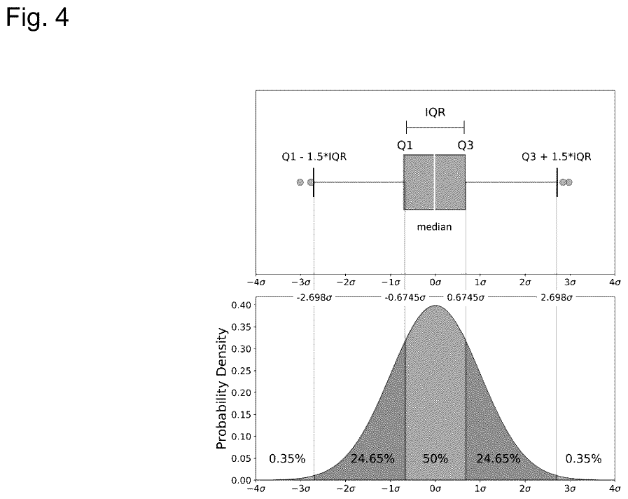

FIG. 4 shows a schematic distribution of measured values for the spindle current. The probability density for the spindle current is plotted as a function of the standard deviation G.

Several measured values can be used to calculate the spindle current. From a set of different measured values for the spindle current, the 50% that are distributed closest around a mean value can be determined. If a sample of the measured values is sorted by size, the interquartile range (IQR) indicates the width of the interval Q1 to Q3 is in which the average 50% of the sample elements lie.

The interquartile range of the measured values for the spindle current can also be used to determine the wear of the tool 101. For example, the interquartile range of the measured values for the spindle current can be determined during the milling process of the dental restoration 200. However, this can also be done downstream. The interquartile range increases linearly with the wear of the tool 101. The dimensional error also increases linearly due to the wear on the dental restoration. Therefore, it is possible to determine the wear of the tool from the interquartile range.

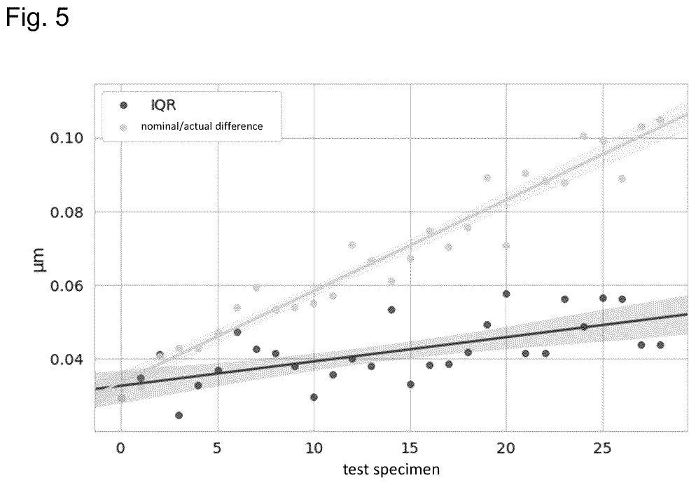

FIG. 5 shows interquartile ranges as a function of nominal/actual differences of consecutively manufactured test specimens with one tool and thus visually represents the correlation between wear of the tool and the IQR. The number of manufactured test specimens is plotted on the X-axis. On the Y-axis there is plotted a difference between a nominal dimension and an actual dimension and a interquartile range IQR in μm. The greater the difference between the nominal dimension and the actual dimension, the greater is the interquartile range IQR from the measured values of the spindle current.

The interquartile range IQR of the spindle current behaves linearly with the wear of the tool 101. Therefore, the actual condition of the tool 101 can be determined in real time (“On The Fly”) from the determined interquartile range IQR. The interquartile range behaves like the dimensional deviation (MAE—Mean Absolute Error: 0.015−0.022 mm).

First, a set of measured values for the spindle current is determined. The interquartile range IQR is calculated from these measured values. The greater this interquartile range, the greater is the wear of the tool 101.

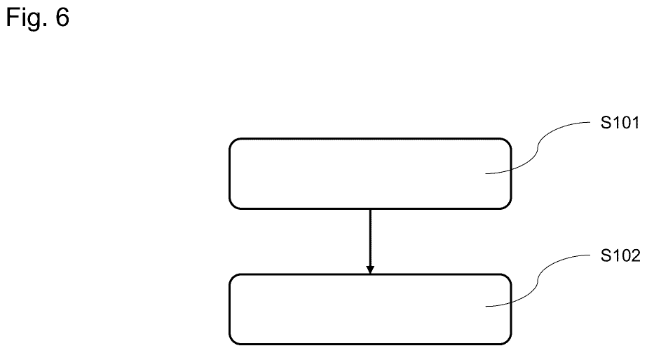

FIG. 6 shows a block diagram of a manufacturing method for the dental restoration 200. In the first step S101, the spindle current of the turning spindle 117 is detected. Here, a plurality of measured values for the spindle current can be detected.

In the subsequent step S102, the wear of the tool 101 is calculated on the basis of the spindle current. For this purpose, the measured values can be evaluated so that, for example, an interquartile range is determined from them. The wear of the tool 101 is determined from the interquartile range, for example by multiplying it by a proportionality factor. These steps can be performed by the calculator 105.

The manufacturing method allows the condition of a tool to be determined on the machine without additional sensor data, microscope or other technical aids.

All of the features explained and shown in connection with individual embodiments of the invention may be provided in different combinations in the subject matter of the invention to simultaneously implement their beneficial effects.

All process steps can be implemented by devices which are suitable for executing the respective process step. All functions that are executed by concrete features can be a process step of a process.

In some embodiments, the innovations may be implemented in diverse general-purpose or special-purpose computing systems. For example, the computing environment can be any of a variety of computing devices (e.g., desktop computer, laptop computer, server computer, tablet computer, gaming system, mobile device, programmable automation controller, etc.) that can be incorporated into a computing system comprising one or more computing devices.

In some embodiments, the computing environment includes one or more processing units and memory. The processing unit(s) execute computer-executable instructions. A processing unit can be a central processing unit (CPU), a processor in an application-specific integrated circuit (ASIC), or any other type of processor. In a multi-processing system, multiple processing units execute computer-executable instructions to increase processing power. A tangible memory may be volatile memory (e.g., registers, cache, RAM), non-volatile memory (e.g., ROM, EEPROM, flash memory, etc.), or some combination of the two, accessible by the processing unit(s). The memory stores software implementing one or more innovations described herein, in the form of computer-executable instructions suitable for execution by the processing unit(s).

A computing system may have additional features. For example, in some embodiments, the computing environment includes storage, one or more input devices, one or more output devices, and one or more communication connections. An interconnection mechanism such as a bus, controller, or network, interconnects the components of the computing environment. Typically, operating system software provides an operating environment for other software executing in the computing environment, and coordinates activities of the components of the computing environment.

The tangible storage may be removable or non-removable, and includes magnetic or optical media such as magnetic disks, magnetic tapes or cassettes, CD-ROMs, DVDs, or any other medium that can be used to store information in a non-transitory way and can be accessed within the computing environment. The storage stores instructions for the software implementing one or more innovations described herein.

The input device(s) may be, for example: a touch input device, such as a keyboard, mouse, pen, or trackball; a voice input device; a scanning device; any of various sensors; another device that provides input to the computing environment; or combinations thereof. The output device may be a display, printer, speaker, CD-writer, or another device that provides output from the computing environment.

The scope of protection of the present invention is given by the claims and is not limited by the features explained in the description or shown in the figures.

### LIST OF REFERENCE SIGNS

100 Manufacturing device
101 Tool
103 Detection device
105 Calculating device
107 Milling surface
109 Digital memory
111 Replacement device
113 Electric motor
115 Microprocessor
117 Turning spindle
200 Dental restoration
201 Blank

1. A manufacturing device for a dental restoration, comprising
a tool for machining a blank;
a detector for detecting a spindle current of a turning spindle; and
a tool wear calculator device for calculating wear of the tool based on the spindle current.

2. The manufacturing device according to claim 1,
wherein the tool wear calculator is configured to calculate the wear from a plurality of measured values of the spindle current.

3. The manufacturing device according to claim 2,
wherein the tool wear calculator is configured to sum or average the spindle current from a plurality of measured values.

4. The manufacturing device according to claim 1,
wherein the tool wear calculator is configured to calculate the wear from a sliding time window for the spindle current.

5. The manufacturing device according to claim 1,
wherein the tool wear calculator is configured to calculate an interval for the average 50% of the values of the spindle current.

6. The manufacturing device according to claim 5,
wherein the tool wear calculator is configured to calculate the wear from the width of the interval.

7. The manufacturing device according to claim 6,
wherein the tool wear calculator is configured to calculate the wear of the tool in proportion to the width of the interval.

8. The manufacturing device according to claim 1,
wherein the manufacturing device is configured to compensate for the wear of the tool during the machining process.

9. The manufacturing device according to claim 1,
wherein the manufacturing device comprises a tool replacer for replacing a worn tool with an unworn tool.

10. The manufacturing device according to claim 9,
wherein the tool replacer is configured to automatically change the tool when a predetermined wear level is exceeded.

11. A manufacturing method for a dental restoration, comprising the steps of
detecting a spindle current of a turning spindle; and
calculating wear of the tool based on the spindle current.

12. The manufacturing method according to claim 11,
wherein the wear is calculated from a plurality of measured values of the spindle current.

13. The manufacturing method according to claim 11,
wherein the wear is calculated from a sliding time window for the spindle current.

14. The manufacturing method according to claim 11,
wherein an interval is calculated for the average 50% of the values of the spindle current.

15. The manufacturing method according to claim 14,
wherein the wear is calculated from the width of the interval.
